(19) United States
(12) Patent Application Publication
(10) Pub. No.: US 2007/0242406 A1
(43) Pub. Date: Oct. 18, 2007

(54) ELECTRICITY GENERATING APPARATUS UTILIZING A SINGLE MAGNETIC FLUX PATH

(76) Inventors: Theodore C. Annis, Ann Arbor, MI (US); J. Patrick Eberly, Cincinnati, OH (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/735,746

(22) Filed: Apr. 16, 2007

Related U.S. Application Data
(60) Provisional application No. 60/792,602, filed on Apr. 17, 2006.
(60) Provisional application No. 60/792,596, filed on Apr. 17, 2006.
(60) Provisional application No. 60/792,594, filed on Apr. 17, 2006.
(60) Provisional application No. 60/792,595, filed on Apr. 17, 2006.

(51) Int. Cl. H01H 47/00

(52) U.S. Cl. 361/147

(57) ABSTRACT

Methods and apparatus generate electricity through the operation of a circuit based upon a single magnetic flux path. A magnetizable member provides the flux path. One or more electrically conductive coils are wound around the member, and a reluctance or flux switching apparatus is used to control the flux. When operated, the switching apparatus causes a reversal of the polarity (direction) of the magnetic flux of the permanent magnet through the member, thereby inducing alternating electrical current in each coil. The flux switching apparatus may be motionless or rotational. In the motionless embodiments, two or four reluctance switches are operated so that the magnetic flux from one or more stationary permanent magnet(s) is reversed through the magnetizable member. In alternative embodiments the flux switching apparatus comprises a body composed of high-permeability and low-permeability materials, such that when the body is rotated, the flux from the magnet is sequentially reversed through the magnetizable member.

### CROSS-REFERENCE TO RELATED APPLICATIONS

This application claims priority to U.S. Provisional Patent Application Ser. Nos. 60/792,602; 60/792,596; 60/792,594; and 60/792,595, all filed Apr. 17, 2006. The entire content of each application is incorporated herein by reference.

### FIELD OF THE INVENTION

The present invention relates to methods and apparatus wherein the magnetic flux from one or more permanent magnets is reversed repeatedly in polarity (direction) through a single flux path around which there is wound a conducting coil or coils for the purpose of inducing electricity in the coils.

### BACKGROUND OF THE INVENTION

The electromechanical and electromagnetic methods involved in motional electric generators and alternators are well known. Alternators and generators often employ permanent magnets and usually have a rotor and a stator and a coil or coils in which an EMF (electromotive force) is induced. The physics involved for producing electricity is described by the generator equation V=∫(v×B)·dl.

Permanent magnets made of materials that have a high coercively, a high magnetic flux density a high magnetic motive force (mmf), and no significant deterioration of magnetic strength over time are now common. Examples include ceramic ferrite magnets (Fe₂O₃); samarium cobalt (SmCO₅); combinations of iron, neodymium, and boron; and others.

Magnetic paths for transformers are often constructed of laminated ferrous materials; inductors often employ ferrite materials, which are used for higher frequency operation for both devices. High performance magnetic materials for use as the magnetic paths within a magnetic circuit are now available and are well suited for the (rapid) switching of magnetic flux with a minimum of eddy currents. An example is the FINEMET® nanocrystalline core material made by Hitachi of Japan.

According to Moskowitz, “Permanent Magnet Design and Application Handbook” 1995, page 52, magnetic flux may be thought of as flux lines which always leave and enter the surfaces of ferromagnetic materials at right angles, which never can make true right-angle turns, which travel only in straight or curved paths, which follow the shortest distance, and which follow the path of lowest reluctance.

A “reluctance switch” is a device that can significantly increase or decrease (typically increase) the reluctance (resistance to magnetic motive force) of a magnetic path in a direct and rapid manner and subsequently restore it to its original (typically lower) value in a direct and rapid manner. A reluctance switch typically has analog characteristics. By way of contrast, an off/on electric switch typically has a digital characteristic, as there is no electricity “bleed-through.” With the current state of the art, reluctance switches have magnetic flux bleed-through. Reluctance switches may be implemented mechanically, such as to cause keeper movement to create an air gap, or electrically by several means, or by other means. One electrical means is that of using control coils wound around the flux paths. Another electrical means is the placement within the flux path of certain classes of materials that change (typically increase) their reluctance upon the application of electricity. Another electrical means is to saturate a region of the switch material so that the reluctance increases to that of air by inserting conducting electrical wires into the material as described by Konrad and Brudny in “An Improved Method for Virtual Air Gap Length Computation,” in IEEE Transactions on Magnetics, Vol. 41, No. 10, October 2005.

The patent literature describes a number of constructs that have been devised to vary the amounts of magnetic flux in alternate flux paths by disproportionately dividing the flux from a stationary permanent magnet or magnets between or among alternate flux paths repeatedly for the purpose of generating electricity. The increase of flux in one magnetic path and the corresponding decrease in the other path(s) provide the basis for inducing electricity when coils are wound around the paths. The physics involved for producing electricity by these constructs is described by the transformer equation V=−∫dB/dt·ds. A variety of reluctance switching means have been employed to cause the flux to be increased/decreased through a particular alternate path with a corresponding decrease/increase in the other path and to do so repeatedly.

A means of switching flux along alternate paths between the opposite poles of a permanent magnet have included the flux transfer principle described by R. J. Radus, Engineers' Digest, July, 1963.

A result of providing alternate flux paths of generally similar geometry and permeability is that, under particular conditions, the alternate path first selected or the path selected for the majority of the flux will remain a “preferred path” in that it will retain more flux and the other path, despite the paths having equal reluctance. (There is not an automatic equalization of the flux among similar paths.) Moskowitz, “Permanent Magnet Design and Application Handbook” 1995, page 87 discusses this effect with regard to the industrial use of permanent magnets to lift and release iron and steel by turning the permanent magnet on and (almost) off via reluctance switching that consists of the electric pulsing of coils wound around the magnetic flux paths (the reluctance switches).

Experimental results with four iron rectangular bars (relative permeability=1000) placed together in a square with a bar permanent magnet (flux density measured at one pole=5000 Gauss) between two of the opposing bars roughly in a center position showed that removal and replacement of the one of the end bars that is parallel to the bar magnet will result in about 80% of the flux remaining in the bar that remained in contact. The results further showed that the preferred path must experience an increase of reluctance about 10× of that of the available alternate path before its disproportionate flux condition will yield and transfer to the alternate path.

Flynn U.S. Pat. No. 6,246,561; Patrick, et al. U.S. Pat. No. 6,362,718; and Pedersen U.S. Pat. No. 6,946,938 all disclose a method and apparatus for switching (dividing) the quantity of magnetic flux from a stationary permanent magnet or magnets between and among alternate paths for the purpose of generating electricity (and/or motive force). They provide for the increase of magnetic flux in one path with a corresponding decrease in the other path(s). There are always at least two paths.

### SUMMARY OF THE INVENTION

The present invention relates to methods and apparatus for the production of electricity through the operation of a circuit based upon a single magnetic flux path. A magnetizable member provides the flux path. One or more electrically conductive coils are wound around the member, and a reluctance or flux switching apparatus is used to control the flux. When operated, the switching apparatus causes a reversal of the polarity (direction) of the magnetic flux of the permanent magnet through the member, thereby inducing alternating electrical current in each coil.

According to the invention, the flux switching apparatus may be motionless or rotational. In the motionless embodiments, four reluctance switches are operated by a control unit that causes a first pair of switches to open (increasing reluctance), while another pair of switches close (decreasing reluctance). The initial pair is then closed as the other pair is opened, and so on. This 2×2 opening and closing cycle repeats and, as it does, the magnetic flux from the stationary permanent magnet(s) is reversed in polarity through the magnetizable member, causing electricity to be generated in the conducting coils. An alternative motionless embodiment uses two reluctance switches and two gaps of air or other materials.

In alternative embodiments, the flux switching apparatus comprises a body composed of high-permeability and low-permeability materials, such that when the body is rotated, the flux from the magnet is sequentially reversed through the magnetizable member. In the preferred embodiment the body is cylindrical having a central axis, and the body rotates about the axis. The cylinder is composed of a high-permeability material except for section of low-permeability material that divided the cylinder into two half cylinders. At least one electrically conductive coil is wound around the magnetizable member, such that when the body rotates an electrical current is induced in the coil. The body may be rotated by mechanical, electromechanical or other forces.

A method of generating electrical current, comprises the steps of providing a magnetizable member with an electrically conductive coil wound therearound, and sequentially reversing the flux from a permanent magnet through the member, thereby inducing electrical current in the coil.

### BRIEF DESCRIPTION OF THE DRAWINGS

FIG. 1 is a schematic diagram of a magnetic circuit according to the invention;

FIG. 2 is a perspective view of an embodiment of the invention based upon motionless magnetic flux switches;

FIG. 3 is a detail drawing of a motionless flux switch according to the invention;

FIG. 4 is a detail drawing of a reluctance switch according to the invention

FIG. 5 is a detail drawing of an alternative motionless flux switch according to the invention which utilizes gaps of air or other materials;

FIG. 6 is a schematic diagram of a system using a rotary flux switch according to the invention;

FIG. 7 is a detail drawing of a rotary flux switch according to the invention;

FIG. 8 is a schematic diagram of a circuit according to the invention utilizing two permanent magnets and a single flux path;

FIG. 9 shows one possible physical embodiment of the apparatus with the components of FIG. 8, including a reluctance switch control unit; and

FIG. 10 shows and array of interconnected electrical generators according to the invention.

### DETAILED DESCRIPTION OF THE PREFERRED EMBODIMENTS

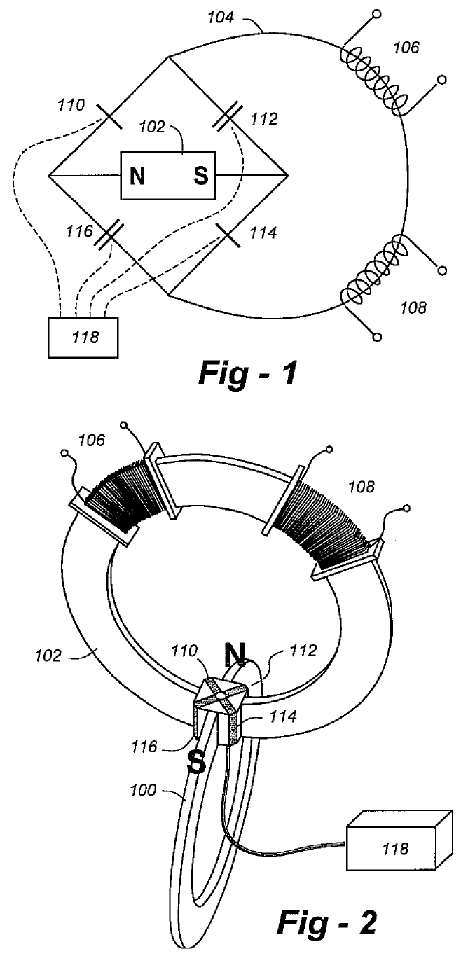

FIG. 1 is a schematic diagram of a magnetic circuit according to the invention utilizing a motionless flux switch. The circuit includes the following components: a permanent magnet 102, single flux path 104, conducting coils 106, 108, and four reluctance switches 110, 112, 114, 116. Under the control of unit 118, reluctance switches 110, 114 open (increasing reluctance), while switches 112, 116 close (decreasing reluctance). Reluctance switches 110, 114 then close, while switches 112, 116 open, and so on. This 2×2 opening and closing cycle repeats and, as it does, the magnetic flux from stationary permanent magnet 102 is reversed in polarity through single flux path 104, causing electricity to be generated in conducting coils 106, 108.

An efficient shape of permanent magnet 102 is a “C” in which the poles are in close proximity to one another and engage with the flux switch. The single flux is carried by a magnetizable member 100, also in a “C” shape with ends that are in close proximity to one another and also engage with the flux switch. In this and in other embodiments, the 2×2 switching cycle is carried out simultaneously. As such, control circuit 118 is preferably implemented with a crystal-controlled clock feeding digital counters, flip-flops, gate packages, or the like, to adjust rise time, fall time, ringing and other parasitic effects. The output stage of the control circuit may use FET (field-effect switches) to route analog or digital waveforms to the reluctance switches as required.

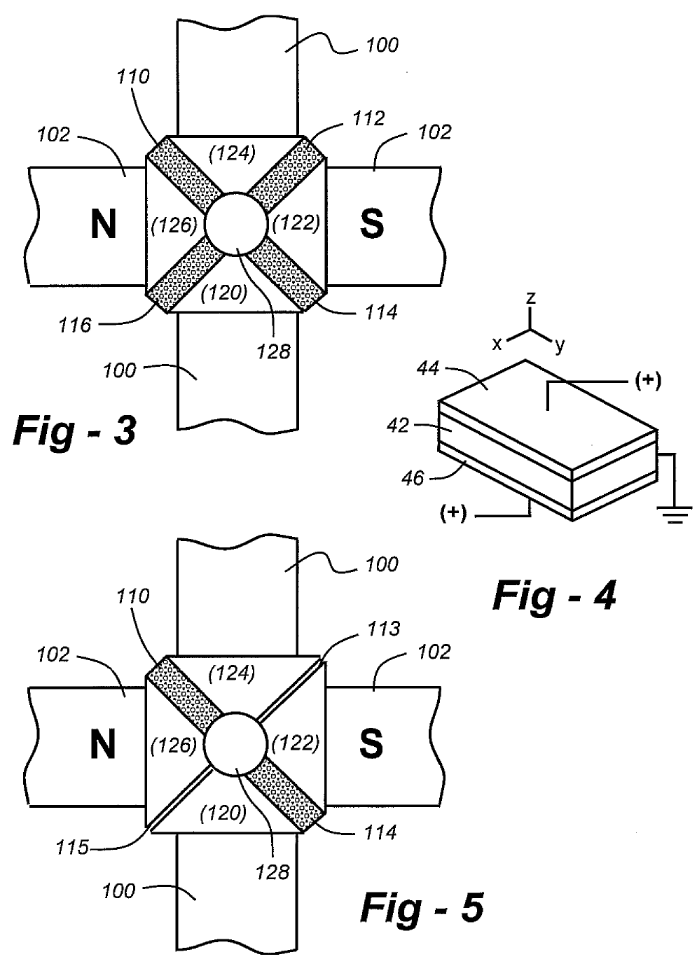

FIG. 2 is a perspective of one possible physical embodiment of the apparatus using the components of FIG. 1, showing their relative positions to one another. Reluctance switches 110, 112, 114, 116 may be implemented differently, as described below, but will usually occupy the same relative position within the apparatus. FIG. 3 is a detail drawing of the motionless flux switch. Connecting segments 120, 122, 124, 126 must be made of a high-permeability ferromagnetic material. The central volume 128 may be a through-hole, providing an air gap, or it may be filled with glass, ceramic or other low-permeability material. A superconductor or other structure exhibiting the Meissner effect may alternatively be used.

In the embodiment depicted in FIGS. 2 and 3, reluctance switches 110, 112, 114, 116 are implemented with a solid-state structure facilitating motionless operation. The currently preferred motionless reluctance switch is described by Toshiyuki Ueno & Toshiro Higuchi, in the paper “Investigation on Dynamic Properties of Magnetic Flux Control Device composed of Lamination of Magnetostrictive Material Piezoelectric Material,” The University of Tokyo 2004, the entirety of which is incorporated herein by reference. As shown in FIG. 4, this switch is made of a laminate of a GMM (Giant Magnetostrictive Material 42), a TbDyFe alloy, bonded on both sides by a PZT (Piezoelectric) material 44, 46 to which electricity is applied. The application of electricity to the PZT creates strain on the GMM, which causes its reluctance to increase.

Other arrangements are applicable, including those disclosed in pending U.S. Patent Application Serial no. 2006/0012453, the entire content of which is incorporated herein by reference. These switches disclosed in this reference are based upon the magnetoelectric (ME) effects of liquid crystal materials in the form of magnetorestrictive and piezoelectric effects. The properties of ME materials are described, for example, in Ryu et al, “Magnetoelectric Effect in Composites of Magnetorestrictive and Piezoelectric Materials,” Journal of Electroceramics, Vol. 8, 107-1 19 (2002), Filipov et al, “Magnetoelectric Effects at Piezoresonance in Ferromagentic-Ferroelectric Layered Composites,” Abstract, American Physical Society Meeting (March 2003) and Chang et al., “Magneto-band of Stacked Nanographite Ribbons,” Abstract, American Physical Society Meeting (March 2003). The entire content of each of these papers are also incorporated herein.

Further alternatives include materials that may sequentially heated and allowed to cool (or cooled and allowed to warm up or actively heated and cooled) above and below the Currie temperature, thereby modulating reluctance. Gadolinium is a candidate since its Currie point is near room temperature. High-temperature superconductors are other candidates, with the material being cooled in an insulated chamber at a temperature substantially at or near the Currie point. Microwave or other energy sources may be used in conjunction with the control unit to effectuate this switching. Depending upon how rigidly the switches are contained, further expansion-limiting ‘yokes’ may or may not be necessary around the block best seen in FIG. 4.

FIG. 5 is a detail drawing of an alternative motionless flux switch according to the invention which utilizes gaps of air or other materials. This embodiment uses two electrically operated reluctance switches 110, 114, and two gaps 113, 115, such that when the switches are activated in a prescribed manner, the flux from the magnet 102 is blocked along the switch segments containing the switches and forced through the gap-containing segments, thereby reversing the flux through the magnetizable member 100. Upon activation of the two reluctance switches 110, 114, the flux, seeking a path of significantly lower reluctance, flips back to the original path containing the (non deactivated) reluctance switches, thereby reversing the flux through the member 100. Note that the flux switches may also be electromagnetic to saturate local regions of the switch such that reluctance increases to that of air (or gap material), creating a virtual gap as described by Konrad and Brudny in the Background of the Invention.

More particularly, flux switching apparatus according to this embodiment uses a permanent magnet having a north pole ‘N’ and a south pole ‘S’ in opposing relation across a gap defining a volume. A magnetizable member with ends ‘A’ and ‘B’ is supported in opposing relation across a gap sharing the volume, and a flux switch comprises a stationary block in the volume having four sides, 1-4, with two opposing sides interfaced to N and S, respectively and with the other two opposing sides being interfaced to A and B, respectively. The block is composed of a magnetizable material segmented by two electrically operated magnetic flux switches and two gaps filled with air or other material(s). A control unit in electrical communication with the flux switches is operative to:

a) passively allow a default flux path through sides 1-2 and 3-4, then

b) actively establish a flux path through sides 2-3 and 1-4, and

c) repeat a) and b) on a sequential basis.

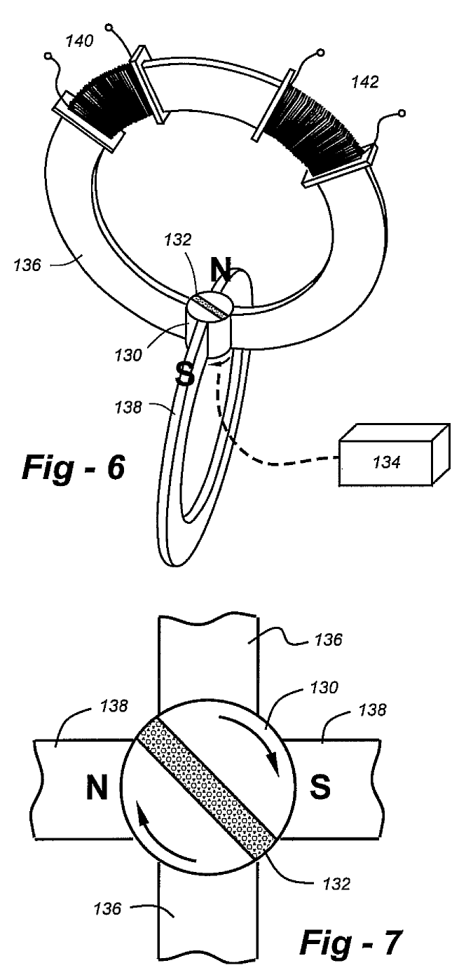

As an alternative to a motionless flux switch, a rotary flux switch may be used to implement the 2×2 alternating sequence. Referring to FIGS. 6 and 7, cylinder 130 with flux gap 132 is rotated by a motive means 134. This causes the halves of cylinder 130 to provide two concurrent and separate magnetic flux bridges (i.e., a “closed” reluctance switch condition), in which a given end of magnetizable member 136 is paired up with one of the poles of stationary permanent magnet 138. Simultaneously, the other end of single flux path carrier 136 is paired up with the opposite pole of stationary permanent magnet 138.

FIG. 7 is a detail view of the cylinder. Each 90° rotation of the cylinder causes the first flux bridges to be broken (an “open” reluctance switches condition) and a second set of flux bridges to be created in which the given end of member 136 is then bridged with the opposite pole of stationary permanent magnet 138. A full rotation of cylinder 130 causes four such reversals. Each flux reversal within single flux path 2 causes an electric current to be induced in conducting coil(s) 140, 142. In this embodiment, it is important to keep a precise, consistent spacing between each of the “halves” of (rotating) cylinder 130 in relation to the poles of permanent magnet 138 and the ends of flux path carrier 136 as the magnetic flux bridges are provided by the cylinder 130 as it rotates.

Rotating cylinder 130 is made of high magnetic permeability material which is divided completely by the flux gap 132. A preferred material is a nanocrystalline material such as FINEMET® made by Hitachi. The flux gap 132 may be air, glass, ceramic, or any material exhibiting low magnetic permeability. A superconductor or other structure exhibiting the Meissner effect may alternatively be used.

An efficient shape of magnetizable member 136 is a “C” in which its opposing ends are curved with a same radius as cylinder 130 and are in the closest possible proximity with rotating cylinder 130. Permanent magnet 138 is also preferably C-shaped in which the opposing poles are curved with a same radius as cylinder 130 and are in the closest possible proximity with rotating cylinder 130. Manufacturing and assembly considerations may dictate other shapes.

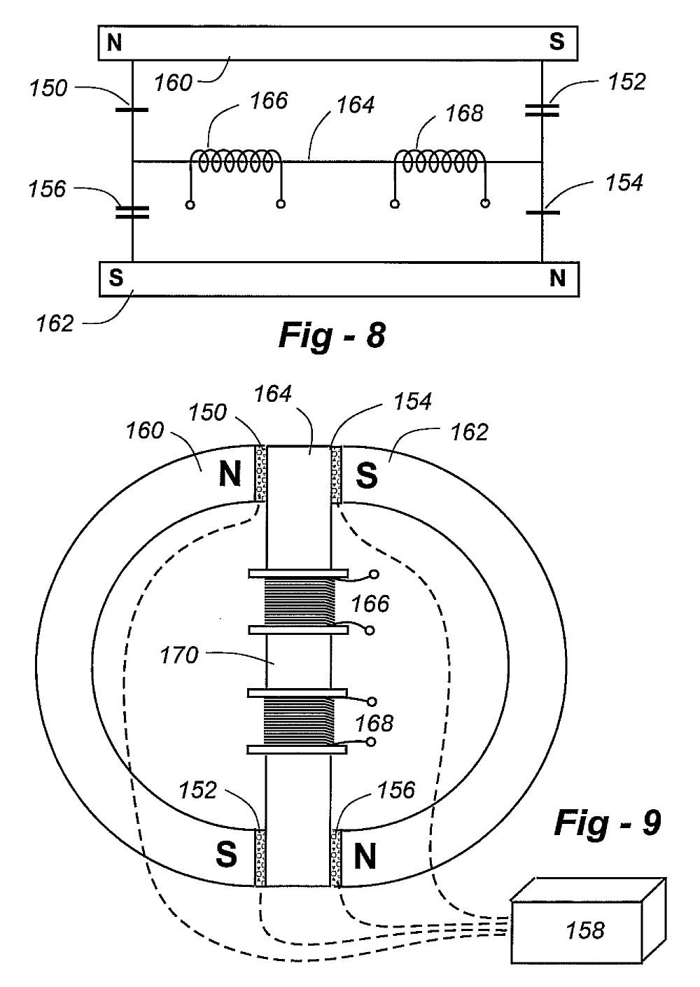

While the embodiments described thus far utilize a single permanent magnet, other embodiments are possible according to the invention utilizing a plurality of permanent magnets while nonetheless generating a single flux path. FIG. 8 depicts a circuit utilizing two permanent magnets and a single flux path. FIG. 9 shows one possible physical embodiment of the apparatus based upon the components of FIG. 8, including a reluctance switch control unit 158.

Under the control of unit 158, reluctance switches 150, 152 open (increasing reluctance), while switches 154, 156 close (decreasing reluctance). Reluctance switches 150, 152 then close, while switches 154, 156 open, and so on. This 2×2 opening and closing cycle repeats and, as it does, the magnetic flux from stationary permanent magnets 160, 162 is reversed in polarity through the magnetizable member, causing electricity to be generated in conducting coils 166, 168.

In the preferred implementation of this embodiment, the magnets are arranged with their N and S poles reversed. The magnetizable member is disposed between the two magnets, and there are four flux switches, SW1-SW4, two between each end of the member and the poles of each magnet. The reluctance switches are implemented with the structures described above with reference to FIGS. 1 to 3.

For added particularity, assume the first magnet has north and south poles, N1 and S1, the second magnet has north and south poles, N2 and S2 and the member has two ends A and B. Assuming SW1 is situated between N1 and A, SW2 is between A and S2, SW3 is between N2 and B, and SW4 is between B and S1, the control circuitry operative to activate SW1 and SW4, then activate SW2 and SW3, and repeat this process on a sequential basis. As with the other embodiments described herein, for reasons of efficiency, the switching is carried out simultaneously.

In all of the embodiments described herein the material used for the permanent magnet(s) may be either a magnetic assembly or a single magnetized unit. Preferred materials are ceramic ferrite magnets (Fe₂O₃), samarium cobalt (SmCO₅), or combinations of iron, neodymium, and boron. The single flux path is carried by a material having a high magnetic permeability and constructed to minimize eddy currents. Such material may be a laminated iron or steel assembly or ferrite core such as used in transformers. A preferred material is a nanocrystalline material such as FINEMET®. The conducting coil or coils are wound around the material carrying the single flux path as many turns as required to meet the voltage, current or power objectives. Ordinary, standard, insulated, copper magnet wire (motor wire) is sufficient and acceptable. Superconducting materials may also be used. At least some of the electricity induced in the conducting coils may be fed back into the switch control unit. In this mode of operation, starting pulses of electricity may be provided from a chemical or solar battery, as required.

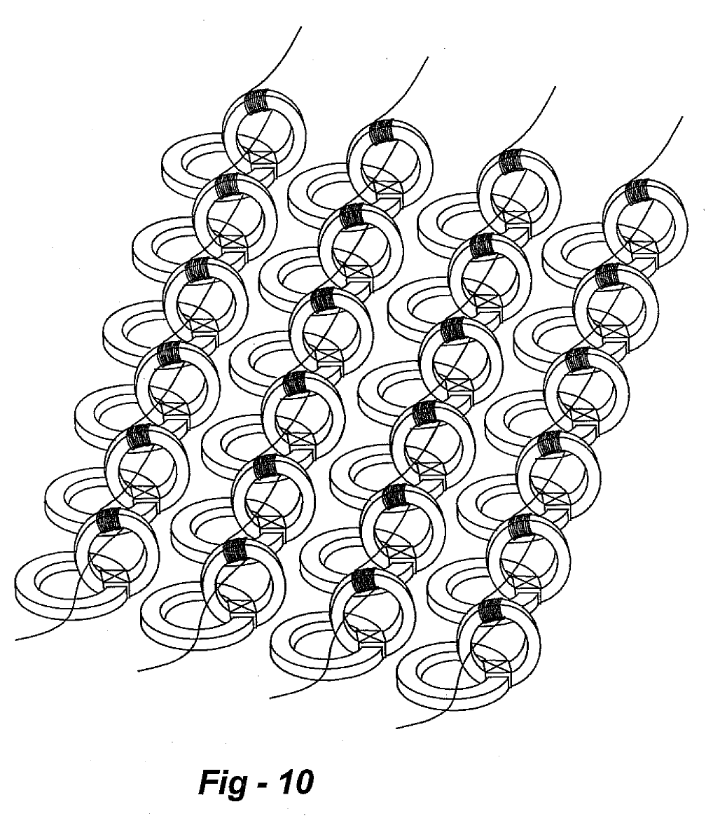

Although in the embodiments of FIGS. 2 and 6 the magnet and flux-carrying materials are flat elements lying in orthogonal planes with flux-carrying material lying outside the volume described by the magnet, the flux path may be disposed ‘within’ the magnet volume or configured at an angle. The physical scale of the elements may also be varied to take advantage of manufacturing techniques or other advantages. FIG. 10, for example, shows an array of magnetic circuits, each having one or more coils that may be in series, parallel, or series-parallel combinations, depending upon voltage or current requirements. In each case the magnets may be placed or fabricated using techniques common to the microelectronics industry. If mechanical flux switches are used they may be fabricated using MEMs-type techniques. If motionless switches are used, the materials may be placed and/or deposited. The paths are preferably wound in advance then picked and placed into position as shown. The embodiment shown in FIG. 9 is also amenable to miniaturization and replication.

We claim:

1. An electrical generator, comprising:
a permanent magnet generating flux;
a magnetizable member;
an electrically conductive coil wound around the magnetizable member; and
flux switching apparatus operative to sequentially reverse the flux from the magnet through the member, thereby inducing electrical current in the coil.

2. The electrical generator of claim 1, wherein the flux switching apparatus includes a plurality of motionless, solid-state reluctance switches.

3. The electrical generator of claim 2, wherein the reluctance switches are composed of a Giant Magnetostrictive Material (GMM) and Piezoelectric (PZT) material.

4. The electrical generator of claim 1, wherein:
the permanent magnet forms a first loop with a north end ‘N’ and a sound end ‘S’ in opposing relation across a gap defining a volume;
the magnetizable member forms a second with ends ‘A’ and ‘B’ in opposing relation across a gap sharing the same volume; and
the flux switching apparatus is disposed in the volume and operative to:
a) magnetically couple N with A and S with B, then
b) magnetically couple N with B and S with A, and
c) repeat steps a) and b) on a sequential basis.

5. The electrical generator of claim 4, wherein the flux switching apparatus comprises:
a stationary block in the volume having four sides, 1-4, with two opposing sides interfaced to N and S, respectively, and with the other two opposing sides being interfaced to A and B, respectively, the block being composed of a magnetizable material segmented by four electrically operated magnetic reluctance switches; and
a control unit in electrical communication with the flux switches, the unit being operative to:
a) establish a flux path through sides 1-2 and 3-4, then
b) establish a flux path through sides 2-3 and 1-4, and
c) repeat a) and b) on a sequential basis.

6. The electrical generator of claim 4, wherein the flux switching apparatus comprises:
a stationary block in the volume having four sides, 1-4, with two opposing sides interfaced to N and S, respectively, and with the other two opposing sides being interfaced to A and B, respectively, the block being composed of a magnetizable material segmented by two electrically operated magnetic reluctance switches and two gaps of air or other materials; and
a control unit in electrical communication with the flux switches, the unit being operative to:
a) passively allow a default flux path through sides 1-2 and 3-4, then
b) actively establish a flux path through sides 2-3 and 1-4, and
c) repeat a) and b) on a sequential basis.

7. The electrical generator of claim 4, wherein the flux switching apparatus comprises a body composed of high-permeability and low-permeability materials, such that when the body is rotated, the flux from the magnet is sequentially reversed through the magnetizable member.

8. The rotary flux switching apparatus of claim 7, wherein the cylinder is composed of a high-permeability material except for section of low-permeability material that divided the cylinder into two half cylinders.

9. The rotary flux switching apparatus of claim 7, wherein the body is mechanically rotated.

10. The rotary flux switching apparatus of claim 7, wherein the body is electromechanically rotated.

11. The electrical generator of claim 1, wherein at least a portion of the electrical current induced in the coil is used to operate the flux switching apparatus.

12. The electrical generator of claim 1, further comprising:
first and second permanent magnets generating magnetic flux in opposite directions; and
a plurality of flux switches operative to sequentially reverse the flux from the magnets through the member, thereby inducing electrical current in the coil.

13. The electrical generator of claim 12, wherein:
the magnets are arranged with their N and S poles reversed;
the magnetizable member is disposed between the two magnets; and
there are four flux switches, SW1-SW4, two between each end of the member and the poles of each magnet.

14. The electrical generator of claim 12, wherein:
the first magnet has north and south poles, N1 and S1;
the second magnet has north and south poles, N2 and S2;
the member has two ends A and B;
SW1 is between N1 and A;
SW2 is between A and S2;
SW3 is between N2 and B;
SW4 is between B and S1; and
further including control circuitry operative to:
a) activate SW1 and SW4, then
b) activate SW2 and SW3, and
c) repeat steps a) and b) on a sequential basis.

15. A method of generating electrical current, comprising the steps of:
providing a magnetizable member with an electrically conductive coil wound therearound; and
sequentially reversing the flux from a permanent magnet through the member, thereby inducing electrical current in the coil.

16. The method of claim 15, further including the step of using at least a portion of the electrical current induced in the coil to sequentially reverse the flux from the permanent magnet through the member.

17. The method of claim 15, further including the step of sequentially reversing the flux from a plurality of permanent magnets through the member, thereby inducing electrical current in the coil.
